(19) United States
(12) Patent Application Publication
(10) Pub. No.: US 2013/0021207 A1
(43) Pub. Date: Jan. 24, 2013

(54) COPLANAR-WAVEGUIDE FED MONOPOLE ANTENNA

(71) Applicant: Youn M. Lee, Clifton, VA (US)

(72) Inventor: Youn M. Lee, Clifton, VA (US)

(21) Appl. No.: 13/184,692

(22) Filed: Jul. 18, 2011

(51) Int. Cl. H01Q 9/06; H01P 11/00

(52) U.S. Cl. 343/700 MS; 29/401.1

(57) ABSTRACT

A planar monopole antenna is provided that includes a dielectric substrate with an electrically conductive antenna element adhered to the substrate surface. A coplanar waveguide is also adhered to the surface of the dielectric substrate in electrical communication with the antenna element. A microwave absorber layer is adhered to an opposing rearward surface of the dielectric substrate. The resultant antenna operates at a reduced return loss and lowers operating frequency compared to an antenna lacking the microwave absorber layer. As a result, an otherwise nonultrawideband antenna is operated as an ultrawideband antenna without increasing the dimensions of the antenna elements through resort to adherence of a microwave absorber layer to the rearward surface of the substrate.

### GOVERNMENT INTEREST

The invention described herein may be manufactured, used, and licensed by or for the United States Government.

### FIELD OF THE INVENTION

The present invention generally relates to a planar monopole antenna such as wireless communication applications and in particular to a planar monopole antenna with an ultrawideband characteristic having a microwave absorber on an opposing face of the antenna substrate.

### BACKGROUND OF THE INVENTION

A monopole antenna is characterized by a simple structure and finds applications in various antenna systems including vehicle mounts and personal communication devices. The operating frequency of a planar monopole antenna is largely dependent on the dielectric constant of the material from which the antenna is fabricated and monopole antenna dimensions. As a result, efforts to reduce monopole antenna dimensions without changing operating frequencies have met with limited success owing to these material and dimensional limitations.

Thus, there exists a need for a coplanar waveguide fed planar monopole antenna with an extended operating frequency range for a given antenna substrate dielectric constant and antenna dimensions.

### SUMMARY OF THE INVENTION

A planar monopole antenna is provided that includes a dielectric substrate with an electrically conductive antenna element adhered to the substrate surface. A coplanar waveguide is also adhered to the same surface of the dielectric substrate to feed the antenna element. A microwave absorber layer is adhered to an opposing rearward surface of the dielectric substrate. The resultant antenna lowers operating frequency compared to an ultrawideband antenna lacking the microwave absorber layer. As a result, the lowest operating frequency of the ultrawideband antenna is lowered by a factor of five when approximately one-inch thick microwave absorber was added to the opposite side of the antenna element and coplanar waveguide.

### BRIEF DESCRIPTION OF THE DRAWINGS

A better understanding of the present invention will be had upon reference to the following detailed description when read in conjunction with the accompanying figures (not to scale), wherein like reference characters used across multiple figures refer to like aspects throughout the various views. These drawings are intended to be exemplary and not to limit the scope of the appended claims, and in which:

FIG. 1A is a top view of an inventive monopole antenna with a circular antenna element, fed by a coplanar waveguide;

FIG. 1B is a top view of an inventive monopole antenna with a rectilinear antenna element;

FIG. 1C is a top view of an inventive monopole antenna with an ellipsoidal antenna element;

FIG. 1D is a top view of an inventive monopole antenna with a pentagonal antenna element;

FIG. 1E is a top view of an inventive monopole antenna with a hexagonal antenna element;

FIG. 1F is an end view of FIG. 1A showing the inclusion of the microwave absorber with the appreciation that the end views of FIGS. 1B-1E are substantially identical hereto;

FIG. 2 is a plot of return loss in decibels as a function of frequency in GHz for the inventive antenna depicted in FIGS. 1A and 1F. The solid line is the measured return loss of the ultrawideband monopole antenna with microwave absorber backing, and the dashed line represents that of an identical antenna absent microwave absorber backing;

FIG. 3 is a plot of measured radiation patterns, H-Plane cut at 800 MHz for the inventive antenna depicted in FIGS. 1A and 1F shown as a solid line pattern, and a dashed line pattern represents that of an identical antenna absent the inventive microwave absorber backing;

FIG. 4 is a plot of measured radiation patterns, E-Plane cut at 800 MHz for the inventive antenna depicted in FIGS. 1A and 1F shown as a solid line, and the dashed line represents that of a like antenna absent the inventive microwave absorber backing.

### DESCRIPTION OF THE PREFERRED EMBODIMENTS

The present invention has utility as a low profile monopole antenna operative in communications. An inventive ultrawideband antenna has an extended operating frequency range through the inclusion of microwave absorber attached to the back of the antenna substrate thereby lowering the operating frequency range of the inventive ultrawideband antenna without increasing antenna footprint.

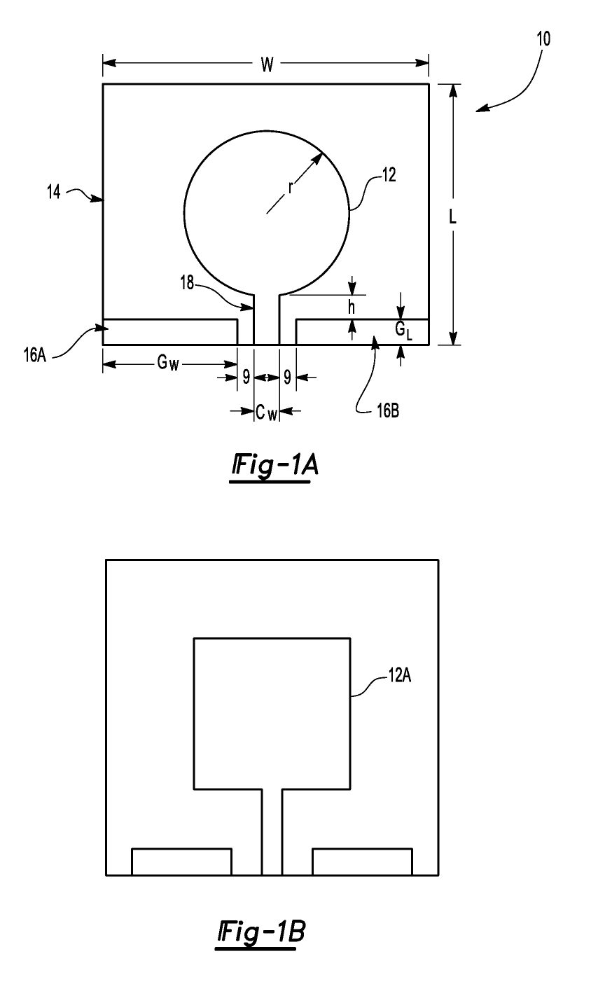

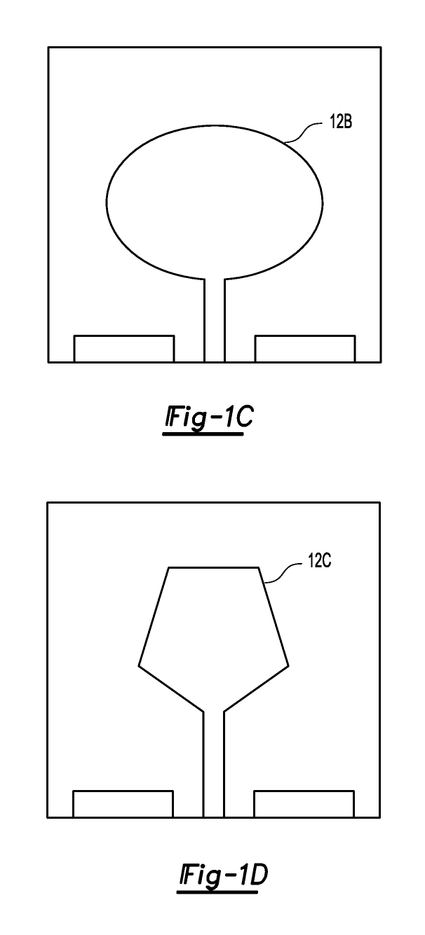

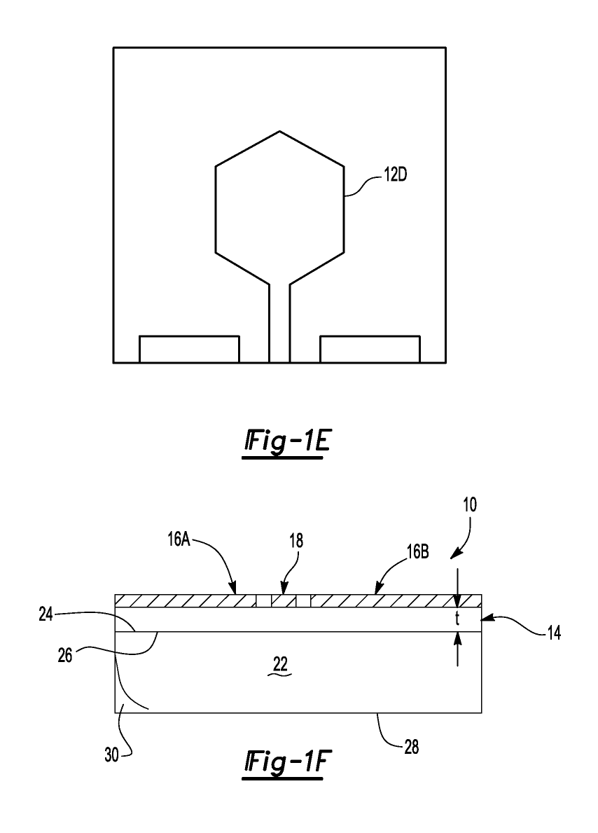

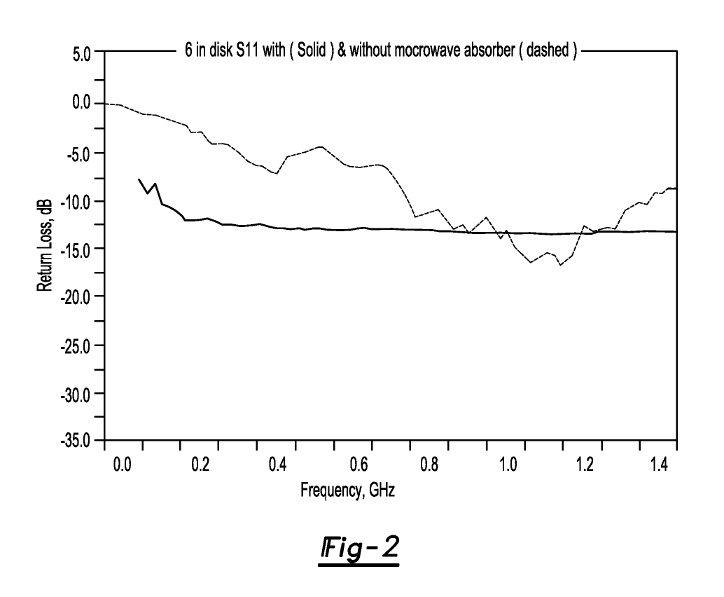

Referring now to FIGS. 1A-1F, an inventive antenna is shown generally at 10. The antenna 10 has an antenna element 12 and an underlying dielectric substrate 14. The antenna element 12 is fed by a coplanar waveguide, consisted of ground planes 16A, 16B, and a center conductor 18. FIGS. 1A and 1F depicts various dimensions associated with performance characteristics of a given antenna 10. These parameters include substrate width W, substrate length L, lateral separation h between antenna element 12 and coplanar waveguide, antenna element radius r, separation gap g between a ground plane and the center conductor 18, width of ground plane G_{W}, lateral extent of ground plane G_{L}, the center conductor of the coplanar waveguide width C_{W}, and the thickness of the dielectric material t. While FIG. 1A depicts a prototypical circular antenna element with the other portions of the antenna 10 being rectilinear, it is appreciated that dimensions of the various components of the antenna 10 need to be very specific to work properly. By way of example, a radiating element is also formed in other geometric shapes and polygons. Such various shapes of antenna elements are depicted in FIGS. 1B-1E and exhibit ultrawideband characteristic [1]. Antenna elements 12a-12d can be formed of the same materials as antenna element 12 and vary only in shape therefrom.

An antenna element 12, center conductor 18, and ground planes 16A and 16B are formed of highly conductive materials conventional to the art illustratively including copper, copper alloys, gold, gold alloys, and combinations thereof. A dielectric substrate is readily formed from a variety of dielectric substances through recognition that the dielectric constant of the substrate 14 is relevant in determining the physical size of an antenna. Dielectric substrates operative herein illustratively include fiberglass reinforced epoxy laminate (NEMA designation FR-4), polytetrafluoroethylene (PTFE) composites reinforced with glass microfibers (such as those commercially available under the trade name DUROID®); and ceramic material such as alumina.

Regardless of a shape of the antenna element 12, 12a-12d, an inventive monopole antenna 10 has a microwave absorber 22 adhered to the rearward surface 24 of dielectric substrate 14. The microwave absorber 22 affords the advantage of an inventive monopole antenna 10 of down shifting the operating frequency range of the like antenna 10 absent microwave absorber without increasing the antenna footprint. It is appreciated that the thickness of the microwave absorber layer 22 is dictated by factors including microwave absorption coefficient. It is appreciated that numerical operating characteristics of a given antenna configuration can be simulated using 3D electromagnetic computer code such as, by way of example, IE3D® simulation software. Thickness of the microwave absorber 22 is depending on operating frequency band and the material that formed the microwave absorber, and therefore, a user needs to conduct experiments to determine adequate thickness for an antenna or antenna array. Substances suitable for the formation of a microwave absorber layer 22 illustratively include carbon fiber impregnated on a porous material such as sponge or foam. The microwave absorber layer 22 is depicted with parallel surfaces 26 and 28; however, it is appreciated that surface 26 while matching the contours of rearward surface 24 of dielectric substrate 14, opposing surface 28 in fact need not be parallel to surface 26 and is readily contoured or otherwise modified for packaging or to modify operational properties of an inventive antenna 10. A representative contour modification of the absorber 22 is shown at 30 in FIG. 1F. In addition, a relatively thin dielectric material can be used to completely enclose the microwave absorber for protection from physical damage or undesired liquid such as water.

The present invention is further detailed with respect to the following examples which are intended to illustrate specific embodiments of the present invention but not to limit the scope of the claimed invention.

### Example 1

An antenna is simulated using a 3D electromagnetic computer code and subsequently fabricated and tested. The antenna has the form of that depicted in FIG. 1A with the fabrication occurring on a 1.575 millimeter thick FR-4 substrate. The antenna dimensions consistent with definitions detailed with respect to FIGS. 1A and 1F are as follows:

w=152 mm

L=152 mm

h=3 mm

r=55 mm

g=0.393 mm

G_{W}=73.607 mm

G_{L}=20 mm

C_{w}=4 mm

t=1.575 mm

Measured return loss of this antenna without microwave absorber is shown as a dashed line in FIG. 2. As shown in Table 1 (the third column, return loss without absorber), frequency range for return loss of 10 dB or higher are 0.88 GHz-1.2 GHz. Therefore, the antenna cannot be characterized as an ultrawideband antenna and constitutes a comparative control for an inventive antenna.

The return loss characteristic of this comparative antenna is radically changed when one-inch thick microwave absorber material is placed on the backside of the dielectric as shown in FIG. 1F to form an inventive antenna. FIG. 2 shows the plotted data of the return loss as a function of frequency, shown as a solid line, which is overlaid onto the return loss measured for the comparative control antenna. FIG. 2 shows drastic improvement in overall return loss, and also exhibits lowering of the operating frequency (defined as 10 dB return loss or better). Therefore, an inventive antenna can now be classified as an ultrawideband antenna without changing the antenna footprint relative to the comparative control. Table 1 lists detailed return loss data as a function of frequency, showing that the operating frequency (return loss of 10 dB or better) is shifted down by 720 MHz for this example.

It should be noted that a return loss of greater than 10 dB of the inventive antenna goes beyond 10 GHz, and however, a radiation pattern starts to deform from an ideal isotropic radiation pattern beyond 1.2 GHz. Therefore, one may not want to use the inventive antenna at higher than 1.2 GHz using the specific dimensions shown in the Example 1.

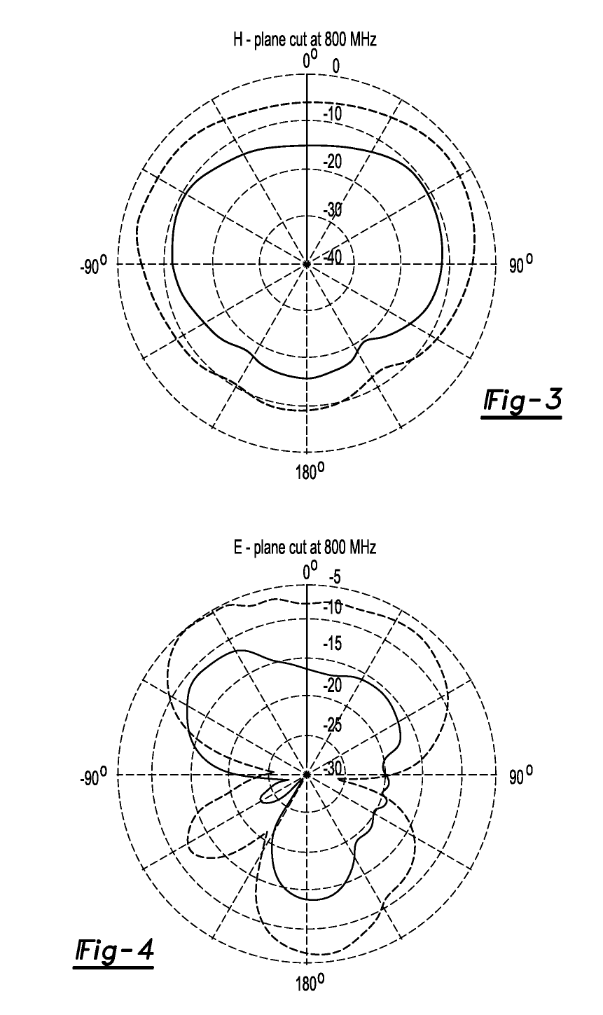

FIG. 3 is a plot showing radiation patterns of the inventive antenna for H-plane cut (solid line pattern) and that of the comparative control (dashed line pattern) measured at 800 MHz. FIG. 4 is a plot showing the radiation patterns of the inventive antenna for E-plane cut (solid line) and that of the comparative control (dashed line) measured at 800 MHz. These plots show loss of gain of the inventive antenna in the presence of the microwave absorber, and however, a low noise small signal amplifier readily compensates for the loss. Gain of the antenna varies as a function of frequency.

It is noted that an inventive antenna does not require a Balun. In addition, the upper frequency data provided in FIG. 2 and Table 1 only valid up to 1.2 GHz.

TABLE 1
Measured return loss of the antenna in dB with and without the microwave
absorber as a function of frequency. A circular monopole antenna was
fabricated on a 6″ by 6″ FR-4 fiberglass.

| | | Comparative |
|---|---|---|
| | Inventive antenna: | antenna: |
| | Return loss with | Return loss without |
| Frequency | microwave absorber | absorber |
| GHz | S11 [dB] | S11 [dB] |
| 0.10 | −7.85 | 0.0139 |
| 0.12 | −9.14 | −0.0409 |
| 0.14 | −8.22 | −0.0962 |
| 0.16 | −10.37 | −0.3927 |
| 0.18 | −10.64 | −0.7625 |
| 0.20 | −11.20 | −1.0986 |
| 0.22 | −12.02 | −1.0522 |
| 0.24 | −12.14 | −1.0455 |
| 0.26 | −11.94 | −1.5154 |
| 0.28 | −11.88 | −1.6659 |
| 0.30 | −12.16 | −2.0819 |
| 0.31 | −12.53 | −2.2347 |
| 0.33 | −12.51 | −3.0713 |
| 0.35 | −12.58 | −3.0231 |
| 0.37 | −12.68 | −4.0538 |
| 0.39 | −12.60 | −4.2523 |
| 0.41 | −12.51 | −4.2137 |
| 0.43 | −12.78 | −4.5704 |
| 0.45 | −12.97 | −5.2814 |
| 0.47 | −12.95 | −6.1385 |
| 0.49 | −13.07 | −6.4896 |
| 0.51 | −12.97 | −6.5182 |
| 0.53 | −13.17 | −7.1827 |
| 0.55 | −13.10 | −7.1051 |
| 0.57 | −13.09 | −5.8532 |
| 0.59 | −13.14 | −5.3533 |
| 0.61 | −13.25 | −5.2553 |
| 0.63 | −13.28 | −4.9747 |
| 0.65 | −13.20 | −4.6196 |
| 0.67 | −13.13 | −4.7465 |
| 0.69 | −13.10 | −5.3694 |
| 0.70 | −13.19 | −6.1628 |
| 0.72 | −13.16 | −6.8162 |
| 0.74 | −13.23 | −6.7403 |
| 0.76 | −13.19 | −6.9059 |
| 0.78 | −13.25 | −6.6567 |
| 0.80 | −13.31 | −6.5074 |
| 0.82 | −13.36 | −6.8694 |
| 0.84 | −13.35 | −7.6800 |
| 0.86 | −13.45 | −8.7852 |
| 0.88 | −13.50 | −10.1257 |
| 0.90 | −13.49 | −12.2052 |
| 0.92 | −13.52 | −11.9891 |
| 0.94 | −13.57 | −11.7245 |
| 0.96 | −13.64 | −11.1326 |
| 0.98 | −13.65 | −12.0393 |
| 1.00 | −13.70 | −13.4147 |
| 1.02 | −13.77 | −13.0456 |
| 1.04 | −13.80 | −13.9722 |
| 1.06 | −13.76 | −12.9330 |
| 1.08 | −13.81 | −12.1303 |
| 1.09 | −13.81 | −12.9951 |
| 1.11 | −13.79 | −14.2050 |
| 1.13 | −13.86 | −13.7354 |
| 1.15 | −13.91 | −15.6122 |
| 1.17 | −13.90 | −16.0142 |
| 1.19 | −13.90 | −16.9903 |

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

As used herein, ultrawideband (UWB) antenna characteristics are defined as an antenna capable of transmitting and/or receiving wireless information over a fractional bandwidth of greater than 0.2 or bandwidth greater than 500 megahertz where the 500 megahertz band is either continuous or an aggregation of narrower carrier bands totaling in summation at least 500 megahertz. It is appreciated that UWB operative herein includes both modulated and pulsed information signals.

### REFERENCE

1. Allen B., Dohler M., Okon, E. E., Malik, W. Q., Brown A. K., and Edwards, D. J., “Ultra-wide band Antennas and Propagation for Communications, Radar, and Imaging”, John Wiley & Sons, Ltd, West Sussex, England 2007.

1. A planar monopole antenna comprising:
a dielectric substrate having a first surface and an opposing rearward surface;
an electrically conductive antenna element adhered to the first surface of said dielectric substrate;
an electrically conductive coplanar waveguide in electrical communication with said antenna, said coplanar waveguide adhered to the first surface of said dielectric substrate;
two ground planes adhered to the first surface of said dielectric substrate as part of the coplanar waveguide; and
a microwave absorber layer adhered to the rearward surface of said dielectric substrate.

2. The antenna of claim 1 wherein said dielectric substrate is composed of fiberglass reinforced epoxy laminate (FR-4), polytetrafluoroethylene; (PTFE) composites reinforced with glass microfibers, ceramic, or a combination thereof.

3. The antenna of claim 1 wherein said dielectric substrate is rectilinear in shape.

4. The antenna of claim 1 wherein said electrically conductive antenna element is circular.

5. The antenna of claim 1 wherein said electrically conductive antenna element is rectilinear, ellipsoidal, pentagonal, hexagonal, or polygon with seven or more sides, or arbitrary in shape.

6. The antenna of claim 1 wherein said two ground planes are rectilinear.

7. The antenna of claim 1 wherein said microwave absorber layer is formed of carbon powder impregnated on sponge.

8. The antenna of claim 1 wherein said microwave absorber layer has a thickness of between 2 to 3 centimeters.

9. The antenna of claim 1 wherein said microwave absorber layer can be contoured.

10. The antenna of claim 1 further comprising a contact adhesive intermediate between the rearward surface and said microwave absorber layer.

11. A process of converting a nonultrawideband antenna as an ultrawideband antenna comprising: constructing an antenna comprising:
a dielectric substrate having a first surface and an opposing rearward surface;
an electrically conductive antenna element adhered to the first surface of said dielectric substrate;
an electrically conductive coplanar waveguide in electrical communication with said antenna, said coplanar waveguide adhered to the first surface of said dielectric substrate;
attaching a microwave absorber layer to the rearward surface of said dielectric substrate to form the ultrawideband antenna;
energizing the ultrawideband antenna with a reduced return loss and lower operating frequency compared to the nonultrawideband and an ultrawideband antenna.

12. The process of claim 11 wherein the energizing step occurs at a frequency of between 0.16 and 1.2 gigahertz.

13. The process of claim 11 wherein the energizing step occurs at a frequency of between 0.16 and 1.2 gigahertz to maintain omnidirectional radiation pattern.

14. The process of claim 11 further comprising providing a low noise signal amplifier in electrical communication with the ultrawideband antenna.

15. The operating frequency range of the antenna with microwave absorber can readily be changed by scaling up or down of the antenna element size and correspondingly sizes of dielectric substrate, coplanar wave guide, and the microwave absorber.
